(19) United States
(12) Patent Application Publication
(10) Pub. No.: US 2003/0028427 A1
(43) Pub. Date: Feb. 6, 2003

(54) User control of electronic personal information while browsing the Web

(75) Inventors: Rabindranath Dutta, Austin, TX (US); Kamal Chandrakant Patel, Cedar Park, TX (US)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation, Armonk, NY (US)

(21) Appl. No.: 09/920,522

(22) Filed: Aug. 2, 2001

(51) Int. Cl. G06F 17/60; G06F 15/16

(52) U.S. Cl. 705/14; 709/203

(57) ABSTRACT

The systems, methods and programs of the present invention enable personal information of a user to be controlled, by the user, in a network environment. A client machine, having stored personal information of a user, receives a request from a first network entity to send the stored personal information to a specified list of other network entities. The request may include a financial incentive in the form of a discount or coupons for specified goods or services. The specified list is presented to the user at the client in a selectable manner thereby enabling one or more of the network entities to be selected by the user. The personal information can be separately edited for each of the selected network entities. The personal information, as edited, is sent to the selected network entities from the client machine with a copy to the requesting first entity. The requesting network entity may send a remuneration to the user for further distributing the user's personal information to other network entities. In a further embodiment, the client machine watermarks the personal information before sending it to a network entity. A separate watermark may be used for each network entity to which the information is sent.

### BACKGROUND OF THE INVENTION

1. Field of the Invention

The present invention relates to accessing and distributing information over the Internet, and more specifically to controlling the access and distribution of personal information while browsing the Web.

2. Description of the Related Art

As computational devices continue to proliferate throughout the world, there also continues to be an increase in the use of networks connecting these devices. Computational devices include large mainframe computers, workstations, personal computers, laptops and other portable devices including wireless telephones, personal digital assistants, automobile-based computers, etc. Such portable computational devices are also referred to as “pervasive” devices. The term “computer” or “computational device”, as used herein, may refer to any of such device which contains a processor and some type of memory.

The computational networks may be connected in any type of network including the Internet, an intranet, a local area network (LAN) or a wide area network (WAN). The networks connecting computational devices may be “wired” networks, formed using lines such as copper wire or fiber optic cable, wireless networks employing earth and/or satellite-based wireless transmission links, or combinations of wired and wireless network portions. Many such networks may be organized using a client/server architecture, in which “server” computational devices manage resources, such as files, peripheral devices, or processing power, which may be requested by “client” computational devices. “Proxy servers” can act on behalf of other machines, such as either clients or servers.

A widely used network is the Internet. The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite or protocols.

Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML).

In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”.

A browser is a program capable of submitting a request for information identified by an identifier, such as, for example, a URL, receiving the requested information or page identified by the URL, and rendering the requested page on a display.

Cookies are bits of data, usually stored on a hard drive at the client, as a result of the client visiting a Web site. Typically, the data includes the user name and password, in a coded format, which makes it easier for the client to later access the Web site again without requiring the user to manually log in each time the browser on the client requests a Web page requiring that information. The browser sends the cookie information to the server enabling the client to visit the Web site freely. However, the cookie may contain other information such as the last time the user visited the site, the person's favorite site, and the pages visited. Only the Web site that created the cookie can read the information in that cookie. But once read, technically, the Web site can do anything it wants with the information. Browsers give the client the option of not storing cookies on the hard drive of the client. However, the user loses the advantage of circumventing a manual log on for certain sites. In addition to the use of cookies, software sniffers and detailed examination of Web server logs are also used to track how people use a Web site.

Because the Internet is so ubiquitous in every aspect of business and personal transactions and communications, personal privacy of its users is becoming a major concern. The amount and type of data that can be collected and assimilated for any given user through all of the user's various transactions and communications over the network is astonishing. Such data can include Web sites visited, goods and services bought online, personal information, etc. An assimilation of the types of Web sites visited and on-line buying habits of a user can lend a pretty good picture as to whether or not a user is male or female, single or married or divorced, within a particular age group, with or without children at home, etc. Marketing firms and advertisers relish this type of data on users in order to streamline their marketing and advertising efforts by targeting a specific category of user as identified by such data. Such data is indeed valuable to marketing firms, advertisers, and other commercial entities looking for an identifiable potential customer base. There is a valuable market for data that has been gathered merely from an individual's presence on the Internet. Because of this, it is very common for such data to be shared with, and/or sold to, other commercial entities. From a user's perspective, the user's privacy and restrictions on use of such gathered data is of utmost concern.

In prior art schemes, some Web servers of merchants have stored cookies and personal information only on the user's machine (i.e., the Web client). However, this method has its shortcomings since it still allows the Web server to share the personal information of the user with other merchants. Furthermore, there is no per merchant approval method, i.e., a user cannot control which specific merchants the information will be shared with.

To address privacy concerns of users, various technologies and standards have been developed including the Platform for Privacy Preferences (P3P), the Internet Content and Exchange standard (ICE), and the Open Profiling Standard (OPS). These technologies and standards enable users to have more control over what information about themselves they will allow to be released to other Web sites, and how that information can be used.

For example, Internet Passports live inside of a Web browser which enable a user to specify in a user profile what type of information can be made available to Web sites. Such information may include the user's name, address, occupation, user name, password, age, products bought, sites visited, etc. When a user visits a Web site, the Web site has access to the information in the profile. The Web site can also put information into the profile if the information is of a type that has been allowed by the user, such as URLs visited or products bought.

Although Internet Passports help a user to have more control over the user's private information, the control mechanism does not allow the user to have flexibility in controlling which sites get what information. Essentially, if information is allowed for one site, all sites can get access to the same type of information. Users, however, need a finer granularity in control over what sites may or may not have access to their information. This is especially true when some sites may have essentially no privacy policies or policies that differ in amount of user protection from that of other sites.

### SUMMARY OF THE INVENTION

It is therefore an object of the invention to enable a user to control which Web sites have access to the user's personal information.

It is a further object of the invention to enable a user to separately control the content of the user's personal information that each different Web site has access to.

It is a further object of the invention to enable a user to determine if a specific Web site has further distributed the user's personal information.

The system, method and program of the invention enables a user to store user personal information in the user's machine. The user also has the ability to update the stored information. The stored data may be in an HTML format, XML format, or in a P3P mechanism such as an Internet Passport. Before a requesting network entity, e.g., a merchant Web server, can share the information with another network entity (such as a server, Web site, e-mail destination, or any entity having a network address), the merchant Web server provides the names of these other network entities to the client. The client can selectively choose which of these other network entities the personal information is to be sent to by the client. Since the client sends the information directly to the selected other network entities, the original requesting merchant Web server may provide incentives, e.g., discounts or coupons, to the client if the client does indeed send its personal information to selected network entities.

In further embodiments, the personal information is uniquely watermarked for the different network entities by the user's machine or by a proxy machine. Since the client (or proxy) is watermarking the personal information and sending the watermarked personal information to other network entities, the user has enhanced control of the user's personal information. If the user runs across its own private information being used by an unauthorized network entity, the user can determine, by the watermark, which network entity distributed the private information without authorization. As such, the user can determine if a receiving network entity has further distributed, or misused, the information without authorization.

As further advantages, accuracy of the user's personal information is enhanced and a merchant's liability in case of errors may be reduced. Since the system, method, and program of the present invention gives the user control over requests from a merchant (i.e., a network entity) to share personal user information with other network entities, more privacy is given to on-line users while still providing a way for marketing companies to sell personal data of users to other merchants. The advantages of the present invention are even more appreciated in an environment where laws restrict merchants or other entities from sharing personal information of users.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates a block diagram of a network computing environment in which a preferred embodiment of the present invention may be implemented;

FIG. 2 illustrates a block diagram of a browser program in accordance with a preferred embodiment of the present invention;

FIG. 3 illustrates a file, stored at a client, having a user's personal information in accordance with a preferred embodiment of the invention;

FIG. 4a illustrates a notice sent from a Web server to a client requesting the Web client to send personal information to specified Web servers in accordance with a preferred embodiment of the invention;

FIG. 4b illustrates a dialog window for separately customizing the personal information for each requested network entity; and

FIG. 5 is a bifurcated process flow diagram illustrating the logic at the server and the client in accordance with a preferred embodiment of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

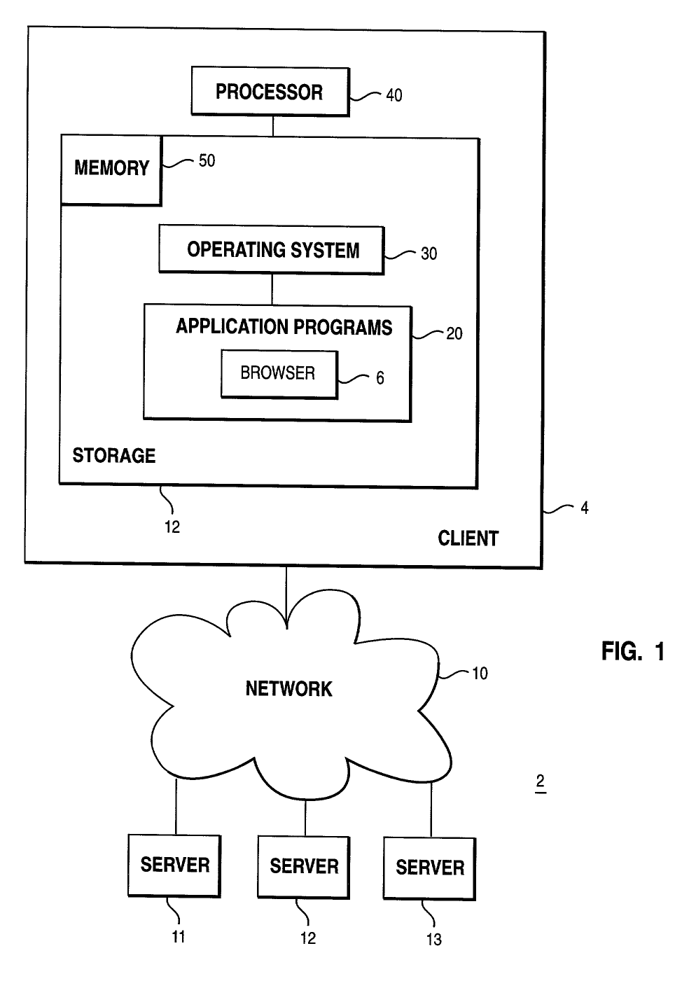

With reference to the figures, and in particular with reference now to FIG. 1, a high-level block diagram of a network computing environment in which a preferred embodiment of the present invention may be implemented is depicted. The computing environment 2 includes at least one client computer 4 including a browser program or viewer program 6, such as the Microsoft Internet Explorer or Netscape Navigator, that is capable of retrieving files from servers 11, 12, 13 over a network 10. The client computer 4 may comprise any computer system known in the art capable of executing a browser program. The servers 11, 12, 13 may comprise any computer system known in the art capable of maintaining files and making such files accessible to remote computers. The browser 6 and servers 11, 12, 13 communicate using a document transfer protocol such as the Hypertext transfer Protocol (HTTP) , or any other document transfer protocol known in the art, such as FTP, Gopher, WAIS, etc. The network 10 may be made up of a TCP/IP network, such as the Internet and World Wide Web, or any network system known in the art, e.g., LAN, Ethernet, WAN, System Area Network (SAN), Token Ring, etc..

The client computer 4 may be, but is not limited to, a personal computer, laptop, workstation, mainframe, or hand held computer including palmtops, personal digital assistant, smart phones, web enabled cellular phones, etc.. Client computer includes processor 40 and memory 50. Memory 50 includes volatile or nonvolatile storage and/or any combination thereof. Volatile memory may be any suitable volatile memory device, e.g., RAM, DRAM, SRAM, etc.. Nonvolatile memory may include storage space 12, e.g., via the use of hard disk drives, tapes, etc., for data, databases, and programs. The programs in memory include an operating system 30 and application programs 20 including a browser program 6. The browser program 6 displays a graphical user interface in which content from a file downloaded from one of the servers 11, 12, 13, such as a HTML page, is displayed. The browser GUI displays graphical buttons to perform operations related to the files downloaded from a server as further described herein.

The client computer 4 includes output devices (not shown) including a display for displaying the browser GUI and Web page and object content. The client computer also includes at least one input device (not shown) through which the user may enter input data to control the operation of the browser program 6, such as a keyboard, mouse, pen-stylus, touch sensitive screen, voice decoder for decoding voice commands, etc.. In preferred embodiments, a user at the client computer 4 can input commands to control the browser program 6 through the graphical user interface (GUI) generated by the browser 6 or input device controls, such as keyboard keys, mouse buttons, touch pad regions, that are programmed to cause the browser to perform specific operations.

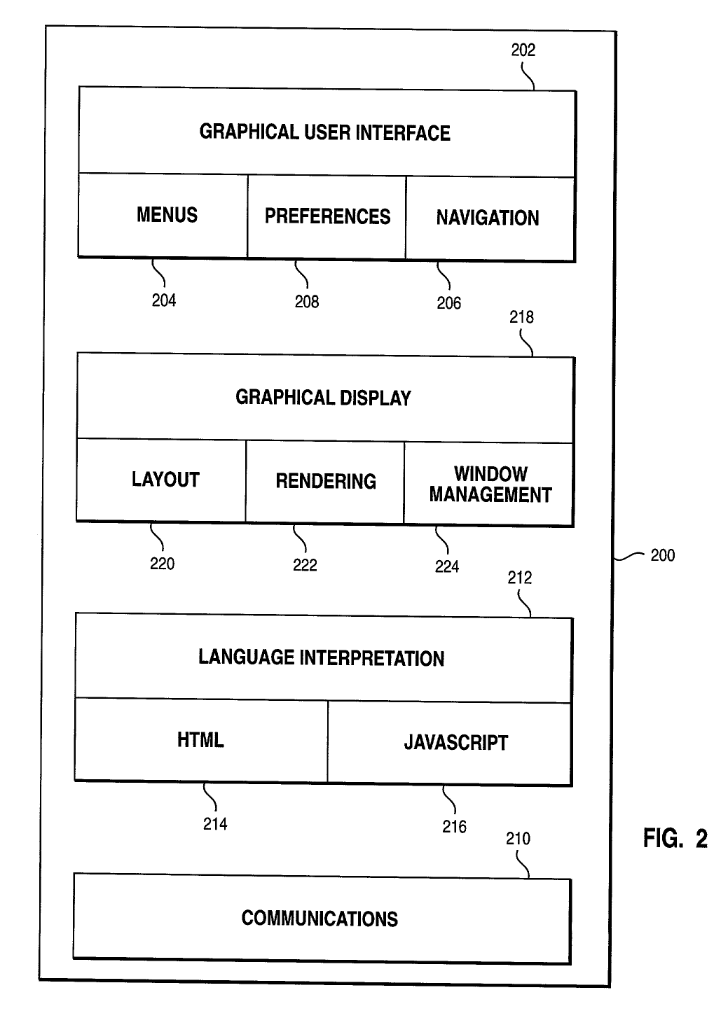

FIG. 2 is an exemplary block diagram of a browser program in accordance with a preferred embodiment of the present invention. A browser is an application used to navigate or view information or data in a network environment, such as the Internet or the World Wide Web.

In this example, browser 200 includes a user interface 202, which is a graphical user interface (GUI) that allows the user to interface or communicate with browser 200. This interface provides for selection of various functions through menus 204 and allows for navigation through navigation 206. For example, menu 204 may allow a user to perform various functions, such as saving a file, opening a new window, displaying a history, and entering a URL. Navigation 206 allows for a user to navigate various pages and to select Web sites for viewing. For example, navigation 206 may allow a user to see a previous page or a subsequent page relative to the present page. Preferences may be set through preferences 208.

Communications 210 is the mechanism with which browser 200 receives documents and other resources from a network such as the Internet. Further, communications 210 is used to send or upload documents and resources onto a network. In the depicted example, communications 210 uses HTTP. Other protocols may be used depending on the implementation. Documents that are received by browser 200 are processed by language interpretation 212, which includes an HTML unit 214 and a JavaScript unit 216. Language interpretation 212 will process a document for presentation on graphical display 218. In particular, HTML statements are processed by HTML unit 214 for presentation while JavaScript statements are processed by JavaScript unit 216.

Graphical display 218 includes layout unit 220, rendering unit 222, and window management 224. These units are involved in presenting Web pages to a user based on results from language interpretation 212.

Browser 200 is presented as an example of a browser program in which the present invention may be embodied. Browser 200 is not meant to imply architectural limitations to the present invention. Presently available browsers may include additional functions not shown or may omit functions shown in browser 200. A browser may be any application that is used to search for and display content in a network environment. Browser 200 may be implemented using known browser applications, such as Netscape Navigator or Microsoft Internet Explorer. Netscape Navigator is a registered trademark of Netscape Communications Corporation and Internet Explorer is a registered trademark of Microsoft Corporation.

The exemplary embodiments shown in FIGS. 1 and 2 are provided solely for the purposes of explaining the preferred embodiments of the invention; and those skilled in the art will recognize that numerous variations are possible, both in form and function.

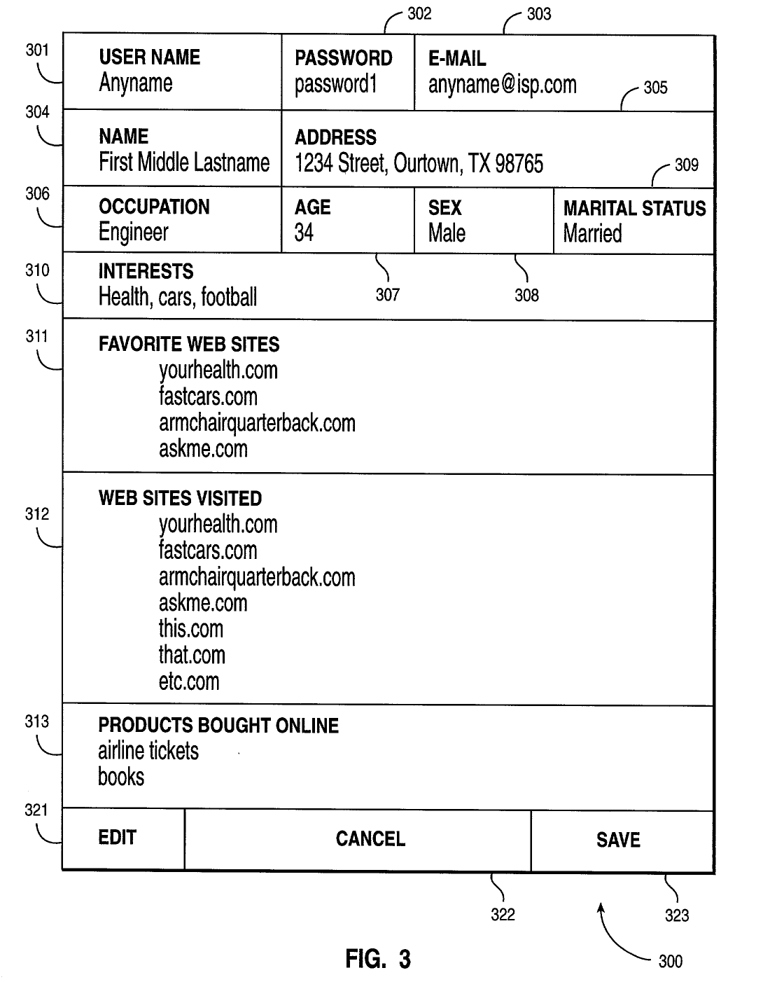

A client's personal information may be stored at the client's machine in the form of cookies, Internet Passports, or other log or file. In some embodiments, the information may be stored at a specific Web site even though the specific Web site may not be able to use such information except for its own uses in servicing the particular user at its site. As shown in FIG. 3, the file 300 may include such personal information such as user name 301, password 302, e-mail 303, name 304, address 305, occupation 306, age 307, sex 308, marital status 309, interests 310, favorite Web sites 311, web sites visited 312, products bought 313, etc. The browser displays the file 300 with selectable buttons edit 321, cancel 322, and save 323. As such a user can edit the information contained within the file, cancel any edited changes, and/or save the edited changes under a new or previous file name or cookie identifier.

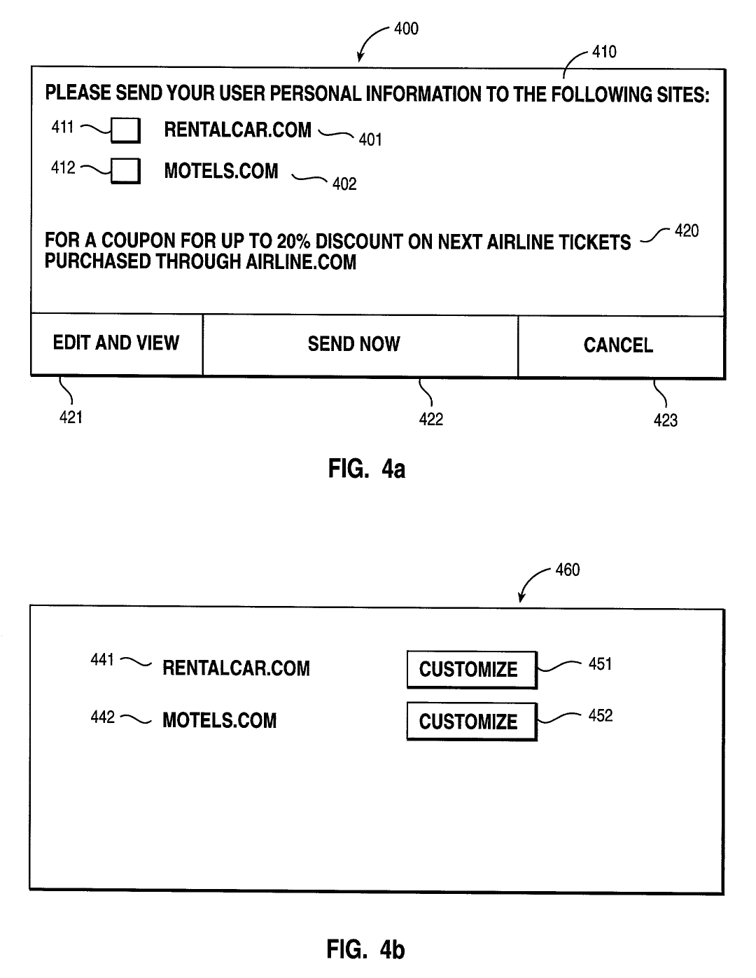

When a user enters a URL request in a browser to access a Web site, the browser examines the cookie file on the hard drive of the client to find a cookie associated with that URL. If one is found, the browser sends the cookie information to the server at the requested URL. That Web server may then contact the user to request the user to send private information to one or more other network entities, e.g., Web servers. This first Web server may then send the user a notice 400 as shown in FIG. 4a either via e-mail or incorporated into a Web page while the user is accessing the Web site.

The notice 400, FIG. 4a, includes a statement 410 requesting the user to send the user's profile to certain Web sites 401, 402. The listed Web sites 401, 402 are user selectable through buttons 411, 412, respectively. The user can view and edit the user's profile information as known by that server by selecting user selectable button 421. It should be noted that in one embodiment, the Web server sends the user profile that the Web server has back to the user upon selection of the edit and view button 421. However, in another embodiment, the browser again retrieves the user profile information for that URL stored at the client's machine and displays it in a separate frame.

In response to a selection of the view and edit button 421, the browser displays dialog 460 as shown in FIG. 4b. Each requested network entity 441, 442 has an associated “customize” button 451, 452 respectively. Upon selecting a “customize” button 451, 452 for a particular network entity, the personal information file, such as shown in FIG. 3, will be displayed to the user for editing. The user edits the user profile information, if desired, by changing or deleting certain information. A separate customized personal information file can then be saved for each specified network entity, e.g., Web site.

Upon selecting the “send now” button 422, FIG. 4a, the browser sends the edited user profile to the Web sites that have been selected. A selection of the cancel button 423 removes the request from the display. In addition, in some embodiments, the browser sends a reply to the Web site stating request denied.

Upon selection of the “view and edit” button 421 and the displaying of the personal information file, the user is enabled to create various versions of the personal information file by deleting some categories of information or changing the content of the various categories, as previously discussed. When the “send now” button is selected, the browser sends the customized file for the particular Web site selected. As such, the user is able to control the actual content of the personal information for each Web site separately. Not only does this enable the user to control to which Web sites the user's personal information will be sent, but it also enables the user to control the content of the personal information at a finer granularity level, i.e., on a per Web site basis.

In one embodiment, upon sending the profile, the Web browser adds a watermark to the profile information. Preferably, a different watermark is used for each different Web site to which the information is sent. The browser then stores the watermarked profile in a file on the client's machine that references the Web site that received it. The watermark may include any type of watermarking including special textual content, background graphics, or subliminal watermarks that are invisible to the human eye. Another type of watermarking may include varying the format or content of various fields within the personal information such as changing the format of the address; or changing the description of the occupation, e.g., using “software programmer” for one Web site and “software developer” for another.

When the Web browser sends the information to the selected Web sites, the Web browser also sends another watermarked version of the user information back to the requesting Web server along with a list of the Web sites to which the information was sent. In this way, the requesting Web site can compare the information sent to what the requesting Web site requested to be sent. For example, the requesting Web site may have requested the information to be send to two Web sites while the information was only actually sent to one of the Web sites. The requesting Web site may also notice that certain information in the user profile has been changed or deleted. The requesting Web site makes a comparison of the initial user profile information that the requesting Web site had access to, and the edited user profile information sent to the requested Web sites. Depending upon the results of the comparison, the requesting Web site adjusts the remuneration to the client for sending the profile information to the requested sites. For example, as shown in FIG. 4a, the requesting Web site stated in the request form 400 that the user would receive a coupon for up to a 20% discount on the next airline tickets purchased through its Web site, 420. If the comparison shows that all of the same information was sent to all of the requested Web sites, the user would receive the full 20% discount. If the user sent the information to only half of the requested Web sites, the user may get only a coupon for a 10% discount. In addition, if the comparison shows that most of the more valuable user profile information was deleted from the information sent, the user may only receive a 1% discount. As such, the requesting Web site may adjust the remuneration to take into account the value of the actual information that the user sent to the requested Web sites.

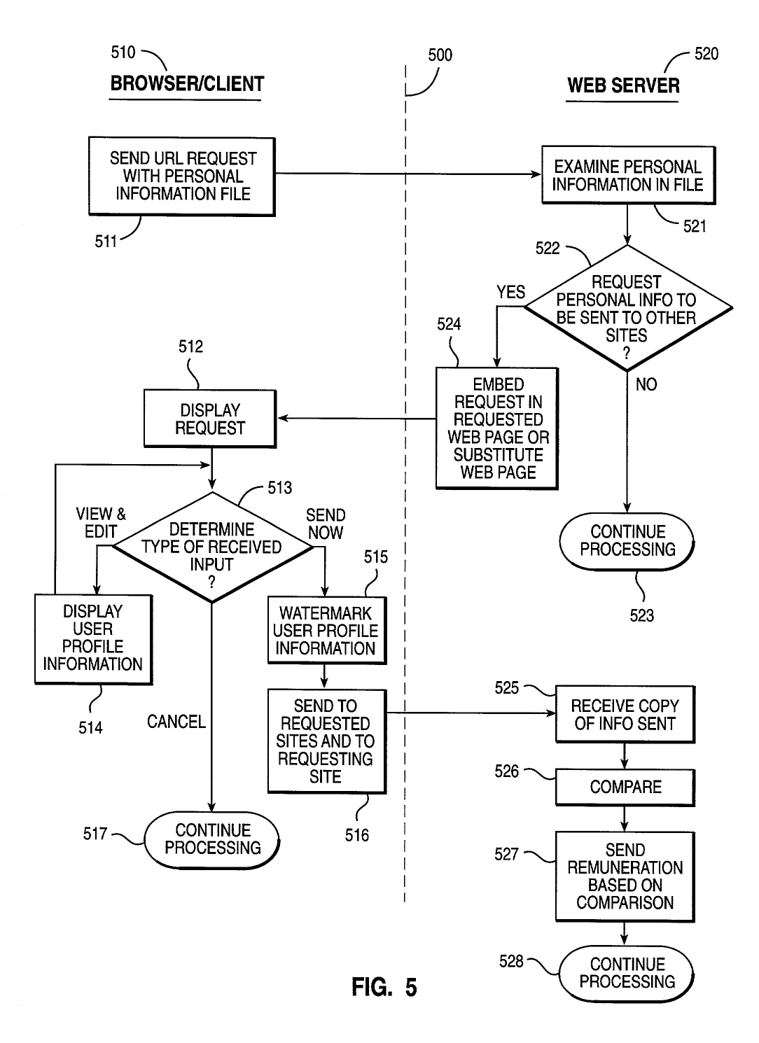

FIG. 5 is a bifurcated process flow diagram illustrating the logic of a preferred embodiment of the invention carried out across a network 500 between a requesting Web server 520 and a browser running at a client 510. The process begins at 511 when the requesting browser at the client 510 sends an URL request with its cookie file or other personal information to a Web server 520. The Web server 520 examines the personal information in the file, 521. The Web server then determines whether or not to request the client to sent the personal information to other Web sites, 522. If it does not, processing continues, 523, such as by sending the requested pages to the requester. Otherwise, the Web server sends a request to the client 524. The request may be embedded in the requested Web page or the request may be sent separately in a separate page, by e-mail or by other messaging embodiments. It should be noted that for some embodiments, the server may randomly decide to request that a user's personal information be sent to other Web sites without first receiving a request for a Web page from the user. That is, for such embodiments, the request to send personal information to other Web sites, 524, would be the first step in the process and would not include steps 511-521.

As shown in the flow diagram of FIG. 5, the browser at the client then displays the request from the Web server, 512. In a preferred embodiment, the request is displayed along with a selectable button enabling the user to view and edit the file containing the user's personal information. The request is also displayed along with user selectable buttons to send the personal information to the selected ones of the requested Web sites and to cancel the request. The browser then determines the type of received input from the user while displaying the request, 513. If input in response to a selection of the “view and edit” button is received, then the browser displays an editable view of the personal information file, 514; and processing continues to step 513 where the browser determines the type of received input. If input in response to a selection of the “send now” button is received, then the personal information file is sent to each of the requested sites that were further selected by the user, 516. In addition, the original Web server 520 that initially requested that the client send personal information to other Web sites is also sent the personal information file as sent to the requested sites.

Optionally, before the personal information file is sent, 516, the browser watermarks the user profile information using various techniques known in the art. Preferably, a different watermark is applied to each copy of the personal information file sent to each different Web site, 515. In this way, if the user ever determines that the user's personal information was utilized in an unauthorized manner, the user can determine, by the watermark, which site mishandled the personal information.

As shown in FIG. 5, the original Web server making the request receives a copy of the personal information file as sent to the other Web sites, 525. The original Web server compares the personal information that was sent to the requested sites with the personal information that the Web site initially had for the user, 526. The Web server sends remuneration to the user based upon the comparison, 527. That is, if the personal information sent is substantially the same as the Web server initially requested the user to send, then the remuneration may be the full amount as initially promised, such as a coupon for discounted services, products, free access time, etc. If the personal information sent is different than what was requested to be sent, then any remuneration would be adjusted accordingly. The Web server then continues processing, 528, as known in the art.

In yet a further embodiment, the personal information sent to the selected other network entities further includes an identification of the requesting network entity. As such, the network entities that receive the user personal information can provide remuneration to the requesting network entity for requesting the user personal information from the user. As such, the requesting network entity can use this remuneration to support the financial incentives offered to the user in the initial request.

As described above, the system, method, and program of the present invention enable personal information of a user to be controlled by the user in a network environment. The user controls which network entities can receive the user's personal information. Furthermore, the content of the personal information can be specified separately for each network recipient. Still yet, the client separately watermarks each personal information file sent to each network recipient. As such, the user can later determine the origin of any personal information that appears to have been further distributed without authorization. The advantages of the invention are further exemplified in an environment where the distribution of personal information is prohibited by third parties by operation of law, agreement, or otherwise.

The preferred embodiments may be implemented as a method, system, or article of manufacture using standard programming and/or engineering techniques to produce software, firmware, hardware, or any combination thereof.

The term “article of manufacture” (or alternatively, “computer program product”) as used herein is intended to encompass data, instructions, program code, and/or one or more computer programs, and/or data files accessible from one or more computer usable devices, carriers, or media. Examples of computer usable mediums include, but are not limited to: nonvolatile, hard-coded type mediums such as CD-ROMs, DVDs, read only memories (ROMs) or erasable, electrically programmable read only memories (EEPROMs), recordable type mediums such as floppy disks, hard disk drives and CD-RW and DVD-RW disks, and transmission type mediums such as digital and analog communication links, or any signal bearing media. As such, the functionality of the above described embodiments of the invention can be implemented in hardware in a computer system and/or in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for use in a CD ROM) or a floppy disk (for eventual use in a floppy disk drive), or downloaded via the Internet or other computer network, as discussed above. The present invention applies equally regardless of the particular type of signal-bearing media utilized.

The foregoing description of the preferred embodiments of the invention has been presented for the purposes of illustration and description. It is not intended to be exhaustive or to limit the invention to the precise form disclosed. Many modifications and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used.

It is intended that the scope of the invention be limited not by this detailed description, but rather by the claims appended hereto. The above specification, examples and data provide a complete description of the manufacture and use of the system method, and article of manufacture, i.e., computer program product, of the invention. Since any embodiments of the invention can be made without departing from the spirit and scope of the invention, the invention resides in the claims hereinafter appended.

Having thus described the invention, what we claim as new and desire to secure by Letters Patent is set forth in the following claims.

1. A method for controlling personal information of a user using a client computer system enabled to be communicatively connected to a plurality of network entities in a network environment, comprising:
storing personal information of the user at the client computer system;
receiving a request from a first network entity to send the personal information stored at the client to at least one other network entity;
enabling the at least one other network entity to be selectable by the user;
enabling the personal information to be edited; and
sending the edited personal information from the client computer system to each of the selected ones of the at least one other network entity.

2. The method of claim 1 wherein enabling the personal information to be edited further comprises enabling the personal information to be separately edited for each selected ones of the at least one other network entity.

3. The method of claim 1 further comprising watermarking the edited personal information before sending the personal information.

4. The method of claim 2 further comprising:
uniquely watermarking each one of the separately edited personal information before sending each of the separately edited personal information to each selected ones of the at least one network entity.

5. The method of claim 1 further comprising receiving an indication of a remuneration from the first network entity in response to sending the edited personal information to selected ones of the at least one network entity.

6. The method of claim 1 wherein receiving a request further comprises receiving, with the request, a financial incentive to comply with the request.

7. A method of participating in a distribution of personal information of a user in a network environment, comprising:
receiving initial personal information from the user over a network;
sending a request to the user requesting the user to send the initial personal information of the user to at least one other specified network entity;
sending, with the request, an indication of a financial incentive to comply with the request; and
receiving a copy of the user personal information sent to the at least one other specified network entity from the user.

8. The method of claim 7 further comprising:
comparing the received copy of the user personal information with the received initial personal information; and
sending a remuneration, based on the comparison, to the user for complying at least in part with the request.

9. The method of claim 8 further comprising:
receiving a first remuneration from each of the at least one other specified network entity to which the user personal information was sent.

10. A method of participating in a distribution of personal information of a user in a network environment, comprising:
receiving personal information of the user from the user with an indication of a requesting network entity; and
sending a second remuneration to the indicated requesting network entity in response to receiving the personal information.

11. A data processing system, comprising:
a communications device enabling communication over a network;
a first memory having a set of instructions;
a second memory having personal information of a user;
a processing unit executing the set of instructions in the first memory to enable receipt of a request from a first network entity through the communications device to send the personal information stored in the second memory to at least one other network entity; to enable the at least one other network entity to be selectable by the user; to enable the personal information to be edited; and to send the edited personal information to each of the selected ones of the at least one other network entity.

12. A computer system enabled to be communicatively connected to a plurality of network entities in a network environment, comprising:
means for storing personal information of a user;
means for receiving a request from a first network entity to send the stored personal information to at least one other network entity;
means for enabling the at least one other network entity to be selectable by the user;
means for enabling the personal information to be edited; and
means for sending the edited personal information to each of the selected ones of the at least one other network entity.

13. The system of claim 12 further comprising means for watermarking the edited personal information before sending the personal information.

14. A computer system enabled to be communicatively connected to a plurality of network entities in a network environment, comprising:
means for receiving initial personal information from a user over a network;
means for sending a request to the user requesting the user to send the initial personal information of the user to at least one other specified network entity;
means for sending, with the request, an indication of a financial incentive to comply with the request; and
means for receiving a copy of the user personal information sent to the at least one other specified network entity from the user.

15. The computer system of claim 14 further comprising:
means for comparing the received copy of the user personal information with the received initial personal information; and
means for sending a first remuneration, based on the comparison, to the user for complying at least in part with the request.

16. The computer system of claim 15 further comprising:
means for receiving a second remuneration from each of the at least one other specified network entity to which the user personal information was sent.

17. A computer system enabled to be communicatively connected to a plurality of network entities in a network environment, comprising:
means for receiving personal information of a user from the user with an indication of a requesting network entity; and
means for sending a remuneration to the indicated requesting network entity in response to the received personal information.

18. A computer program having computer readable instruction code means on a computer usable medium, comprising:
instruction means enabling a storing of personal information of a user;
instruction means enabling receipt of a request from a first network entity to send the stored personal information to at least one other network entity;
instruction means for enabling the at least one other network entity to be selectable by the user;
instruction means for enabling the personal information to be edited; and
instruction means for sending the edited personal information from the client computer system to each of the selected ones of the at least one other network entity.

19. The computer program of claim 18 further comprising instruction means for watermarking the edited personal information before sending the personal information.

20. A computer program having computer readable instruction code means on a computer usable medium, comprising:
instruction means for enabling receipt of initial personal information from a user over the network;
instruction means for sending a request to the user requesting the user to send the initial personal information of the user to at least one other specified network entity;
instruction means for sending, with the request, an indication of a financial incentive to comply with the request; and
instruction means for enabling receipt of a copy of the user personal information sent to the at least one other specified network entity from the user.

21. The computer program of claim 20 further comprising:
instruction means for comparing the received copy of the user personal information with the received initial personal information; and
instruction means for sending a first remuneration, based on the comparison, to the user for complying at least in part with the request.

22. The computer program of claim 21 further comprising:
instruction means for enabling receipt of a second remuneration from each of the at least one other specified network entity to which the user personal information was sent.

23. A computer program having computer readable instruction code means on a computer usable medium, comprising:
instruction means for enabling receipt of personal information of a user from the user with an indication of a requesting network entity; and
instruction means for sending a remuneration to the indicated requesting network entity in response to the received personal information.
